(19) United States
(12) Patent Application Publication
(10) Pub. No.: US 2016/0278011 A1
(43) Pub. Date: Sep. 22, 2016

(54) WIRELESS COMMUNICATION DEVICE, WIRELESS COMMUNICATION SYSTEM, WIRELESS COMMUNICATION METHOD, NON-TRANSITORY RECORDING MEDIUM, CENTRAL AND PERIPHERAL

(71) Applicant: CASIO COMPUTER CO., LTD., Shibuya-ku (JP)

(72) Inventor: Takahiro TOMIDA, Hamura-shi (JP)

(73) Assignee: CASIO COMPUTER CO., LTD., Shibuya-ku (JP)

(21) Appl. No.: 14/392,319

(22) PCT Filed: Jun. 19, 2014
(86) PCT No.: PCT/JP2014/003310

§ 371 Date: Dec. 24, 2015

(30) Foreign Application Priority Data
Jun. 24, 2013 (JP) 2013-132120

(51) Int. Cl. H04W 52/02; H04W 76/02; H04W 48/16

(52) U.S. Cl. CPC H04W 52/0225; H04W 48/16; H04W 76/02

(57) ABSTRACT

An environment information measuring device (200) transmits to a communication terminal (100) an advertisement including a “no_data” flag indicating that there is no data that should be transmitted, when a transmission condition indicating the necessity of data transmission is not satisfied. When the “no_data” flag is not included in the advertisement transmitted by the environment information measuring device (200), the communication terminal (100) executes a connection action process with the environment information measuring device (200) and accomplishes sending data to and receiving data from the environment information measuring device (200). In contrast, when the “no_data” flag is included in the advertisement transmitted by the environment information measuring device (200), the communication terminal (100) does not execute the connection action process with the environment information measuring device (200). In this case, the communication terminal (100) does not accomplish sending data to and receiving data from the environment information measuring device (200).

### TECHNICAL FIELD

The present disclosure relates to a wireless communication device, wireless communication system, wireless communication method, non-transitory recording medium, central and peripheral.

### BACKGROUND ART

A central, that is wireless communication equipment for accomplishing wireless communications based on Bluetooth® low energy that is the short-range wireless communication standard, has been known from before. The central receives identifying information known as an advertisement transmitted by a peripheral, that is other wireless communication equipment that is a communication partner. Furthermore, the central transmits a connection request signal to the peripheral and then sends and receives data with the peripheral. In this kind of wireless communication equipment, curbing power consumption is accomplished during wireless communication with other wireless communication equipment (for example, see Patent Literature 1). The wireless communication equipment of Patent Literature 1 determines the reception interval of advertisements by learning the transmission interval of advertisements transmitted at fixed intervals by the peripheral, and curbs wasted power consumption by shortening the reception action time for each round.

### CITATION LIST

### Patent Literature

[PTL 1]

Unexamined Japanese Patent Application Kokai Publication No. 2012-142877

### SUMMARY OF INVENTION

### Technical Problem

However, with the wireless communication equipment disclosed in Patent Literature 1, when there is no information for updating the data in the peripheral, a connection request signal is transmitted to the peripheral even when there is no change in sensors' measured values with which the peripheral is provided. Consequently, data transmission and reception is accomplished with the peripheral despite the fact that the data has not been updated, so wasted power consumption occurs. In addition, even in the peripheral, when a connection request signal is received from the central that is the communication partner, the data is transmitted to the central despite this being the same data that was transmitted the previous time, so wasted power consumption occurs.

In consideration of the foregoing, it is an objective of the present disclosure to provide a wireless communication device, wireless communication system, wireless communication method, non-transitory recording medium, central and peripheral that can curb wasted power consumption.

### Solution to Problem

A wireless communication device, comprising:

a connection request acquirer which acquires a connection request to connect to an other wireless communication device
a receiver which receives identifying information from the other wireless communication device in response to the connection request being acquired by the connection request acquirer;
a determiner which determines whether or not specific information relating to data that the other wireless communication device should transmit is included in the identifying information received by the receiver; and
a connection controller which controls connections with the other wireless communication device, based on the determination result from the determiner.

### Advantageous Effects of Invention

With the present disclosure, it is possible to curb wasted power consumption.

### BRIEF DESCRIPTION OF DRAWINGS

FIG. 1A is a drawing showing a communication terminal in a wireless communication system according to a preferred embodiment of the present disclosure.

FIG. 1B is a drawing showing an environment information measuring device in a wireless communication system according to a preferred embodiment of the present disclosure.

FIG. 2 is a drawing showing an exemplary composition of a communication terminal as one example of a wireless communication device according to a preferred embodiment of the present disclosure.

FIG. 3 is a drawing showing an exemplary composition of an environment information measuring device as one example of a wireless communication device according to a preferred embodiment of the present disclosure.

FIG. 4A is a drawing showing a WBGT value computation table used when computing WBGT values.

FIG. 4B is a drawing showing classification of WBGT values.

FIG. 5 is a drawing showing an exemplary composition of an advertisement packet.

FIG. 6 is a drawing for explaining actions of the wireless communication system of FIGS. 1A and 1B.

FIG. 7 is a flowchart showing one example of a communication process executed by the communication terminal of FIG. 2.

FIG. 8 is a flowchart showing one example of an advertisement transmission process executed by the environment information measuring device of FIG. 3.

FIG. 9 is a drawing showing an example of a transmission condition expressing whether or not data transmission is necessary in a first variation.

FIG. 10 is a flowchart showing one example of an advertisement transmission process executed by the environment information measuring device in the first variation.

### DESCRIPTION OF EMBODIMENTS

Below, the preferred embodiment of the present disclosure is described with reference to the drawings.

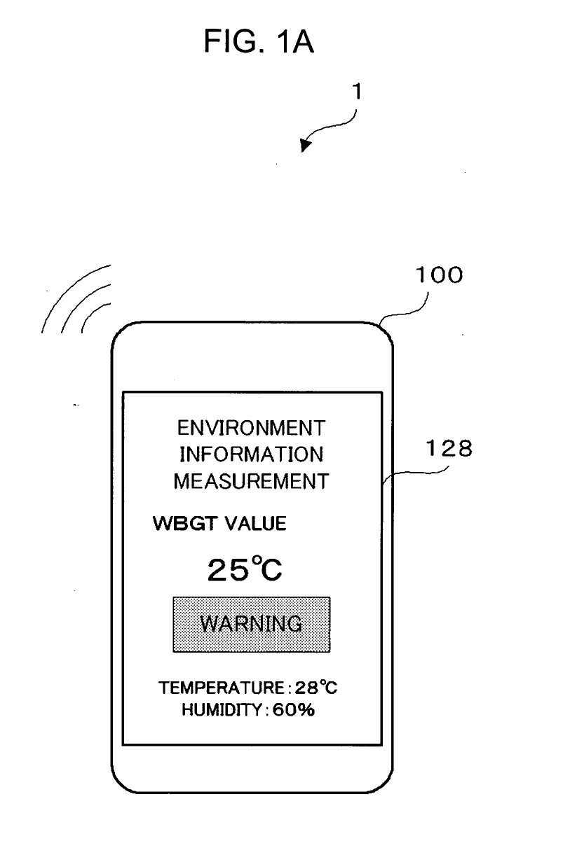

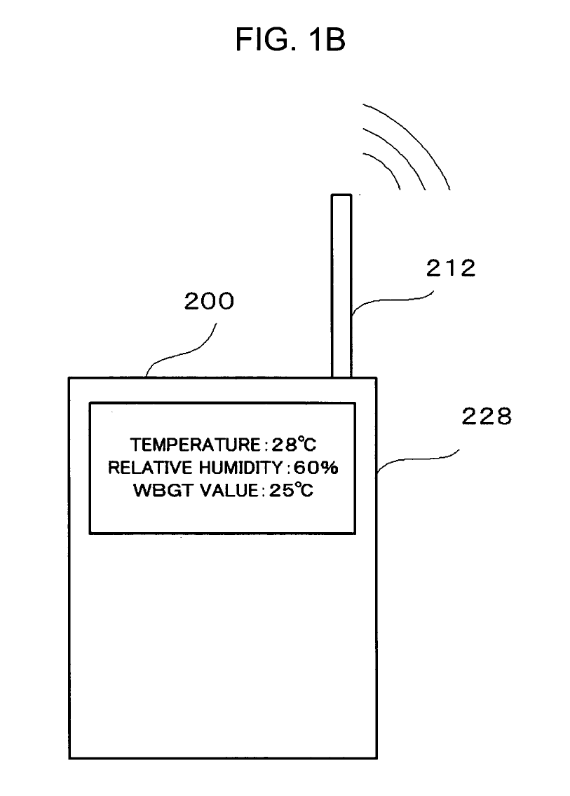

FIGS. 1A and 1B are drawings showing the exemplary composition of a wireless communication system according to a preferred embodiment of the present disclosure.

In the exemplary composition shown in FIGS. 1A and 1B, a wireless communication system 1 comprises a communication terminal 100 as a wireless communication device, and an environment information measuring device 200 as a wireless communication device different from the communication terminal 100. The communication terminal 100 and the environment information measuring device 200 accomplish wireless communication with each other based on Bluetooth® low energy (hereafter referred to as BLE). BLE is a mode formulated with the objective of low power consumption in the short-range wireless communication standard called Bluetooth®. In wireless communication devices that accomplish wireless communications based on BLE, there is a wireless communication device called a central and a wireless communication device called a peripheral. The central is a device that uses services (for example, measured data and/or the like) provided from the peripheral. In addition, the peripheral is a device for providing services (for example, measured data and/or the like) to the central. In this preferred embodiment, the communication device 100 corresponds to the central and the environment information measuring device 200 corresponds to the peripheral.

The communication device 100 can be portable, such as a mobile phone, smartphone, tablet-type personal computer, notebook personal computer and/or the like, and is a terminal having a wireless communication function based on BLE. In this preferred embodiment, the communication terminal 100 comprises a smartphone, as one example. The communication terminal 100 receives data such as temperature, relative humidity and WBGT (Wet Blub Globe Temperature) value and/or the like from the environment information measuring device 200. The communication terminal 100 displays various types of information as environment information on a below-described display device 128 and causes audio such as an alarm and/or the like to sound from a below-described speaker 124, based on the data received. The WBGT value is an index value indicating the extent to which a laborer in a work environment, for example, is susceptible to heatstroke.

The environment information measuring device 200 is placed in a location where the temperature, relative humidity and WBGT value are to be measured, for example a plant, construction site, work site, gymnasium, playground and/or the like. The environment information measuring device 200 measures the temperature and relative humidity of the installation location and computes the WBGT value from the measured values. Furthermore, the environment information measuring device 200 transmits data such as the temperature, relative humidity and WBGT value and/or the like to the communication terminal 100.

With wireless communication accomplished based on BLE, before sending and receiving data between the central and the peripheral, the peripheral transmits an advertisement and the central receives the advertisement. The advertisement is identifying information for notifying other wireless communication devices of the device's own presence, in order to search for other wireless communication devices and connect with other wireless communication devices. The advertisement is sometimes simply called “advertise.”

With this preferred embodiment, the environment information measuring device 200 that is the peripheral transmits an advertisement to the communication terminal 100. At this time, when a below-described transmission condition is not satisfied, the environment information measuring device 200 transmits an advertisement including a “no_data” flag as specific information indicating that there is no data that should be transmitted. In addition, when the below-described transmission condition is satisfied, an advertisement not including the “no_data” flag is transmitted.

The communication terminal 100 that is the central receives the advertisement transmitted by the environment information measuring device 200. At this time, the communication terminal 100 does not execute the connection action process with the environment information measuring device 200 when the “no_data” flag is included in the advertisement received. In addition, the communication terminal 100 executes a connection action process with the environment information measuring device 200 when the “no_data” flag is not included in the advertisement. The communication terminal 100, after executing the connection action process with the environment information measuring device 200, accomplishes sending and receiving of data with the environment information measuring device 200.

Next, the hardware composition of the communication system 1 according to this preferred embodiment is described.

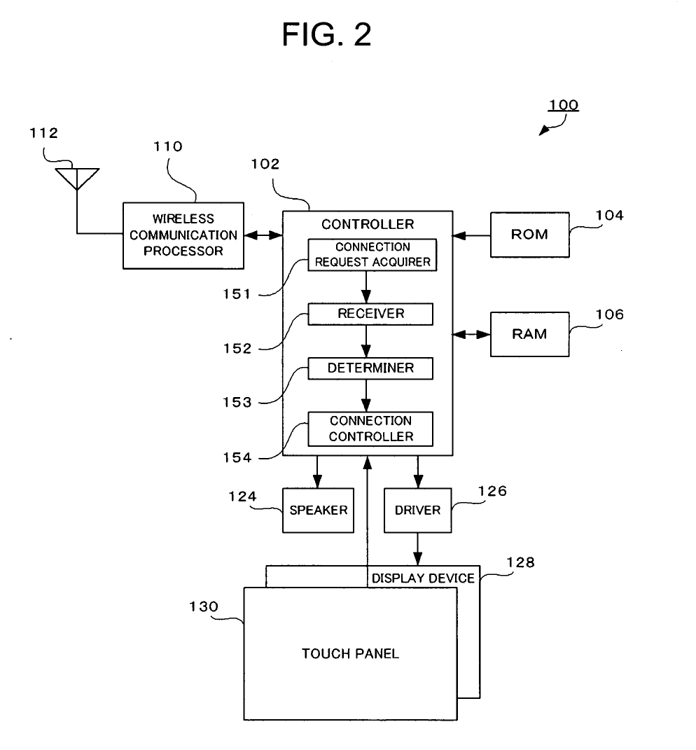

FIG. 2 is a block diagram schematically showing an exemplary composition of the communication terminal 100 according to this preferred embodiment. As shown in FIG. 2, the communication terminal 100 comprises a controller 102, a ROM (Read Only Memory) 104, a RAM (Random Access Memory) 106, a wireless communication processor 110, an antenna 112, a speaker 124, a driver 126, a display device 128 and a touch panel 130.

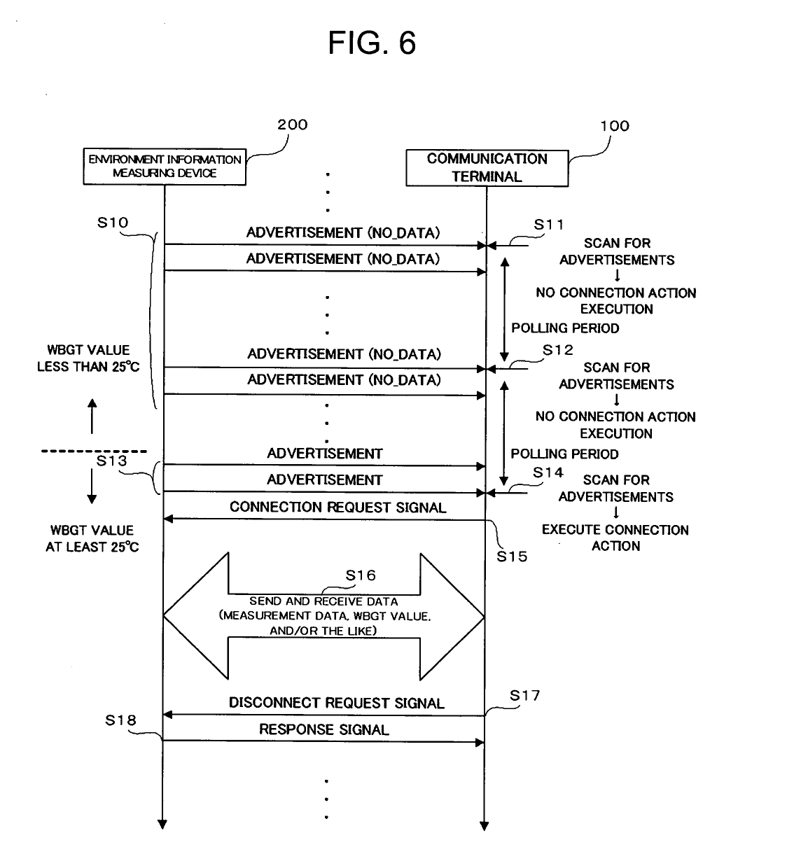

The controller 102 comprises a CPU (Central Processing Unit) and/or the like, for example. The controller 102 controls the various functions with which the communication terminal 100 is equipped by executing software processes in accordance with programs (for example, below-described programs for realizing operation of the communication terminal 100 shown in FIG. 6) stored in the ROM 104.

The ROM 104 comprises non-volatile memory such as flash memory and/or the like, and as noted above stores programs and data for the purpose of the controller 102 controlling various functions. The RAM 106 comprises volatile memory and is used as a work area for temporarily storing data so that the controller 102 can accomplish various processes.

The wireless communication processor 110 is comprised for example using a radio frequency (RF) circuit or baseband (BB) circuit and/or the like. The wireless communication processor 110 transmits and receives wireless signals based on BLE, via the antenna 112.

The speaker 124 outputs audio such as alarms and/or the like based on audio data from the controller 102. The driver 126 outputs image signals to the display device 128 based on image data output from the controller 102. The display device 128 comprises, for example, an LCD (Liquid Crystal Display), EL (Electroluminescence) display and/or the like. The display device 128 displays images (for example, images such as the WBGT value and “warning”, as shown in FIG. 1A, and/or the like) in accordance with image signals output from the driver 126.

The touch panel 130 is positioned on the top surface of the display device 128 and is an interface used for inputting a user's operation content. Built into the touch panel 130 are unrepresented transparent electrodes, for example. Furthermore, when the user's finger and/or the like makes contact, the position where the voltage changes is detected as the contact position, and information about that contact position is output to the controller 102 as input instructions.

Next, the functional composition of the controller 102 of the communication terminal 100 is described. As shown in FIG. 2, the controller 102 functions as a connection request acquirer 151, a receiver 152, a determiner 153 and a connection controller 154.

The connection request acquirer 151 for example acquires the operation to the touch panel 130 accomplished by the user for measuring environment information, after the application for environment information measuring is started up, as a connection request to the environment information measuring device 200. The connection request is not limited to being generated by the user's operation, but for example may be generated based on a preset timer's time elapsing after the application for environment information measuring is launched.

The receiver 152 intermittently executes a reception action process for receiving advertisements with a predetermined polling period after the connection request acquirer 151 has acquired a connection request. The reception action process time may be, for example, set to a longer time than the transmission interval of advertisements transmitted at fixed intervals by the environment information measuring device 200. The receiver 152 scans advertisements in the reception action process and receives advertisements transmitted from the environment information measuring device 200.

The determiner 153 determines whether or not a “no_data” flag indicating that there is no data that should be transmitted is included in the advertisement the receiver 152 received. Specifically, the determiner 153 determines whether or not there is a “no_data” flag in a region where characteristic data can be arbitrarily set, within the composition of the below-described advertisement.

When the determiner 153 has determined that the “no_data” flag is included in the advertisement, the connection controller 154 does not execute the connection action process with the environment information measuring device 200. In addition, when the determiner 153 has determined that the “no_data” flag is not included in the advertisement, the connection controller 154 executes the connection action process with the environment information measuring device 200.

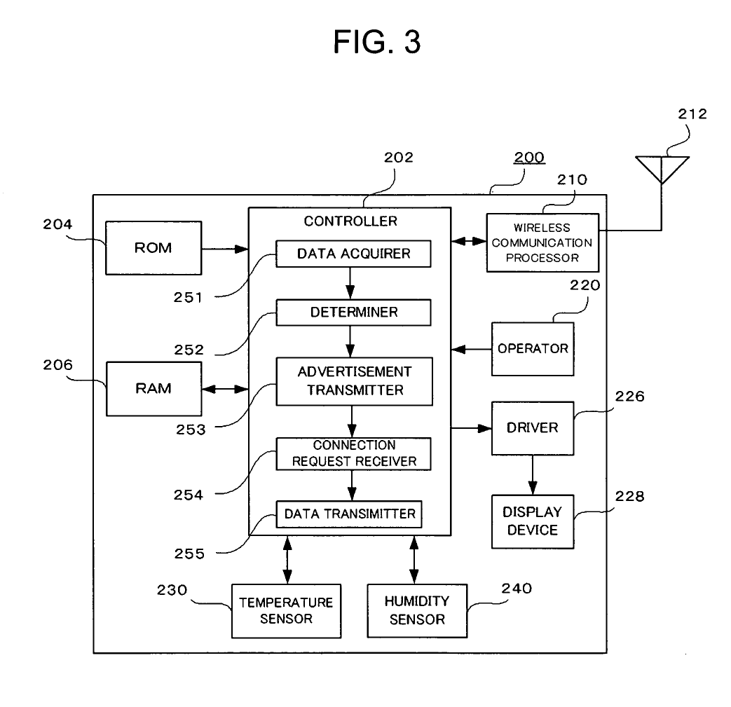

FIG. 3 is a block diagram schematically showing an exemplary composition of the environment information measuring device 200 according to this preferred embodiment. As shown in FIG. 3, the environment information measuring device 200 comprises a controller 202, a ROM 204, a RAM 206, a wireless communication processor 210, an antenna 212, an operator 220, a driver 226, a display device 228, a temperature sensor 230 and a humidity sensor 240.

The controller 202 comprises a CPU, for example. The controller 202 controls the various functions with which the environment information measuring device 200 is equipped by executing software processes in accordance with programs (for example, programs for realizing the actions of the environment information measuring device 200 shown in below-described FIG. 6) stored in the ROM 204.

The ROM 204 comprises non-volatile memory such as flash memory and/or the like, and as noted above stores programs and data for the purpose of the controller 202 controlling various functions. The RAM 206 comprises volatile memory and is used as a work area for temporarily storing data so that the controller 202 can accomplish various processes.

The wireless communication processor 210 is comprised for example using a radio frequency (RF) circuit or baseband (BB) circuit and/or the like. The wireless communication processor 210 transmits and receives wireless signals based on BLE, via the antenna 212.

The operator 220 for example comprises a switch and/or the like, and is used for inputting the user's operation content, such as turning the power source ON/OFF, and/or the like.

The driver 226 outputs to the display device 228 image signals based on image data output from the controller 202. The display device 228 comprises, for example, an LCD, EL display and/or the like. The display device 228 displays images (for example, images showing numerical values such as the temperature, relative humidity, WBGT value and/or the like as shown in FIG. 1B) in accordance with image signals output from the driver 226.

The temperature sensor 230 is comprised using for example a temperature-measuring resistor, a thermocouple and/or the like. The temperature sensor 230 measures the surrounding temperature of the environment information measuring device 200, that is to say the temperature of the location where the environment information measuring device 200 is installed, and sends to the controller 202 data indicating the measurement result.

The humidity sensor is comprised using a polymer film, for example. The humidity sensor 240 measures the relative humidity surrounding the environment information measuring device 200, that is to say the relative humidity of the location where the environment information measuring device 200 is installed, and sends to the controller 202 data indicating the measurement result.

Next, the functional composition of the controller 202 of the environment information measuring device 200 is described. As shown in FIG. 3, the controller 202 functions as a data acquirer 251, a determiner 252, an advertisement transmitter 253, a connection request receiver 254 and a data transmitter 255.

The data acquirer 251 acquires data indicating the temperature measurement result from the temperature sensor 230. In addition, the data acquirer 251 acquires data indicating the relative humidity measurement result from the humidity sensor 240.

The determiner 252 computes the WBGT value from the temperature and relative humidity data acquired by the data acquirer 251, and determines whether or not the computed WBGT value satisfies a below-described transmission condition indicating the necessity of data transmission. In this preferred embodiment, the determiner 252 reads out the WBGT value corresponding to the temperature and relative humidity as a computation result by referencing a WBGT value computation table prepared and stored in advance in the ROM 204.

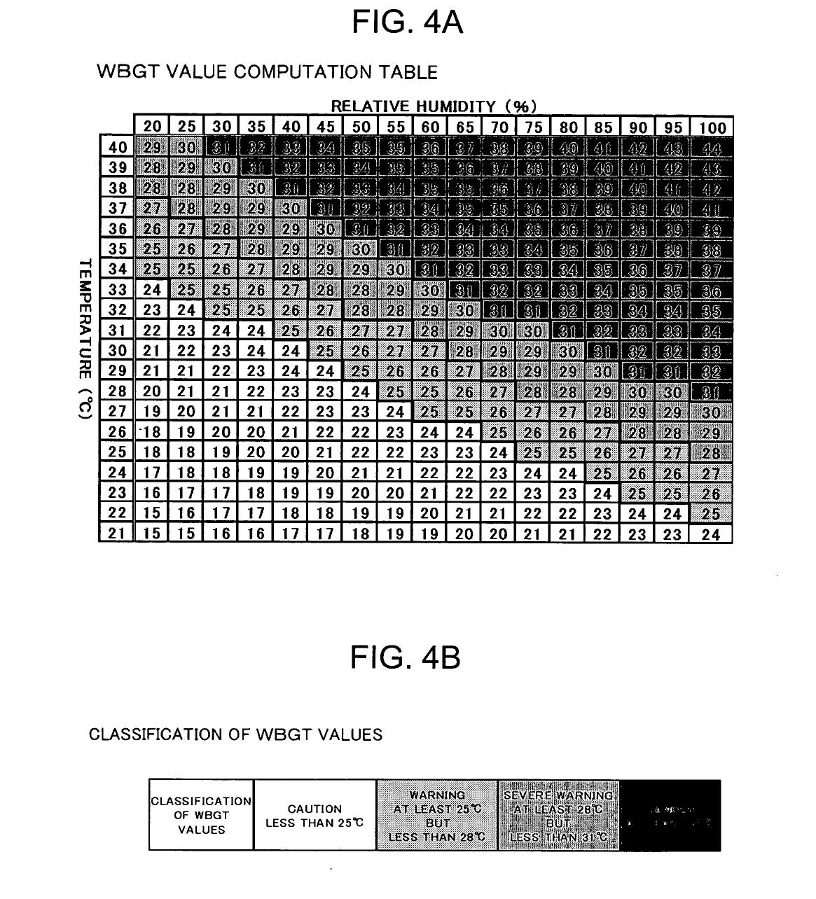

FIG. 4A is a drawing showing one example of a WBGT value computation table used when computing the WBGT value. In the WBGT value computation table shown in FIG. 4A, WBGT values are set in correspondence with temperature and relative humidity. For example, when the temperature is 25 degrees and the relative humidity is 60%, the WBGT value is 23 degrees. In addition, when the temperature is 28 degrees and the relative humidity is 60%, the WBGT value is 25 degrees. The higher the WBGT value, the more likely heatstroke will occur, and in accordance with the degree to which heatstroke is likely to occur, the WBGT value is for example classified in the four classifications of caution (less than 25 degrees), warning (at least 25 degrees but less than 28 degrees), severe warning (at least 28 degrees but less than 31 degrees) and danger (31 degrees or higher), as shown in FIG. 4B.

The determiner 252 shown in FIG. 3 determines whether or not the calculated WBGT value is at least as great as a standard value. In this preferred embodiment, the standard value is taken to be 25 degrees as one example. When the calculated WBGT value is at least 25 degrees, the determiner 252 determines that data transmission to the communication terminal is necessary, that is to say, that the transmission condition is satisfied. In addition, when the calculated WBGT value is less than 25 degrees, the determiner 252 determines that data transmission to the communication terminal 100 is unnecessary, that is to say, that the transmission condition is not satisfied.

When the determiner 252 has determined that data transmission to the communication terminal 100 is unnecessary, the advertisement transmitter 253 shown in FIG. 3 transmits to the communication terminal 100 an advertisement including the “no_data” flag indicating that there is no data that should be transmitted. In addition, when the determiner 252 has determined that data transmission to the communication terminal 100 is necessary, the advertisement transmitter 253 transmits to the communication terminal 100 an advertisement not including the above-described “no_data” flag. The advertisement transmitter 253 transmits an advertisement including the above-described “no_data” flag or an advertisement not including the above-described “no_data” flag at fixed intervals with a predetermined transmission period.

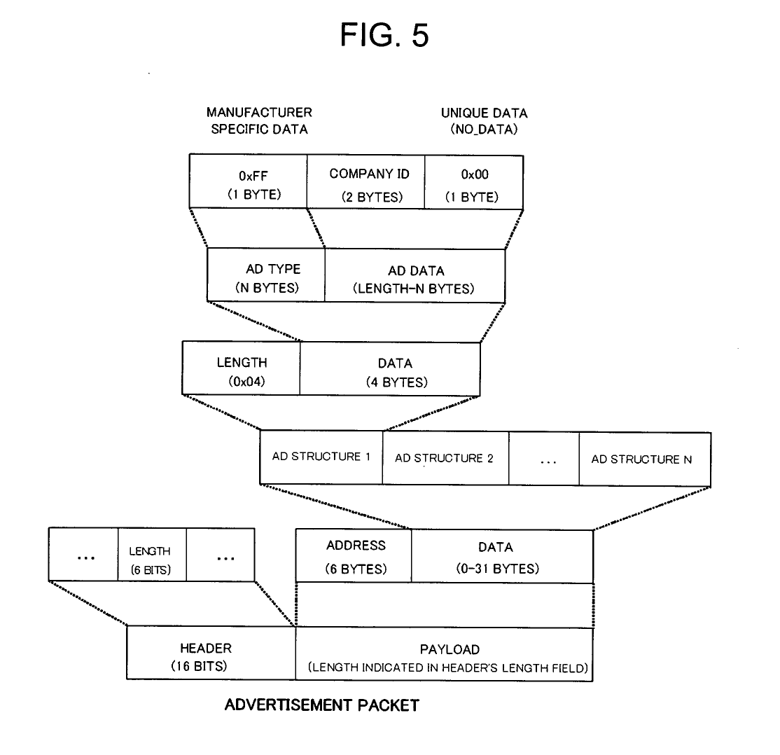

FIG. 5 is a drawing showing an exemplary composition of an advertisement packet transmitted by the advertisement transmitter 253 of the environment information measuring device 200. The advertisement packet shown in FIG. 5 conforms to the BLE standard. Under the BLE standard, it is possible to provide an area in which it is possible to arbitrarily set characteristic data in the advertisement packet. In this preferred embodiment, when the “no_data” flag is included in the advertisement, an area in which the “no data” flag can be set is provided in the advertisement packet, and in that area, data such as “0x00”, for example, is set as data indicating the “no_data” flag. When the “no_data” flag is not included in the advertisement, an area where the “no_data” flag can be set is not provided in the advertisement packet.

For a prescribed interval after the advertisement transmitter 253 has transmitted the advertisement to the communication terminal 100, the connection request receiver 254 shown in FIG. 3 achieves a receivable state in which a connection request signal can be received from the communication terminal 100. Furthermore, the connection request receiver 254 receives a connection request signal from the communication terminal 100 when in the receivable state.

The data transmitter 255 transmits to the communication terminal 100 data such as the temperature, relative humidity and WBGT value acquired by the data acquirer 251, in response to a connection request signal from the communication terminal 100 received by the connection request receiver 254.

Next, the action of the wireless communication system 1 in this preferred embodiment is described with reference to the flowchart in FIG. 6.

The environment information measuring device 200 transmits advertisements including the “no_data” flag to the communication terminal 100 at fixed intervals, as shown in FIG. 6 (step S10). At each transmission time for advertisements in step S10 shown in FIG. 6, the computed WBGT value is less than 25 degrees, and the transmission condition is not satisfied. Accordingly, the advertisement transmitted in step S10 includes the “no_data” flag.

The communication terminal 100 executes a receiving action process for receiving the advertisement, based on the fact that the user has accomplished an operation on the touch panel 130 in order to measure the environment information, for example (step S11). In step S11, the communication terminal 100 scans for advertisements and receives the advertisement transmitted from the environment information measuring device 200. The communication terminal 100 determines that the “no_data” flag is included in the received advertisement. Accordingly, the communication terminal 100 does not execute the connection action process with the environment information measuring device 200.

After the polling period time has elapsed, the communication terminal 100 again executes the reception action process in order to receive an advertisement (step S12). Even in step S12, the communication terminal 100 scans for an advertisement, receives the advertisement sent from the environment information measuring device 200 and determines that the “no_data” flag is included in the advertisement received. Accordingly, the communication terminal 100 does not execute the connection action process with the environment information measuring device 200.

Next, the environment information measuring device 200 transmits advertisements that do not include the “no_data” flag to the communication terminal 100 at fixed intervals (step S13). At each transmission time of the advertisements in step S13, the WBGT value computed by the environment information measuring device 200 is at least 25 degrees, so the transmission condition is satisfied. Accordingly, the advertisements transmitted in step S13 do not include the “no_data” flag.

Next, the communication terminal 100 again executes the receiving action process for receiving the advertisement, after the polling period time has elapsed (step S14). In step S14, the communication terminal 100 scans for advertisements, and receives the advertisement transmitted from the environment information measuring device 200. The communication terminal 100 determines that the “no_data” flag is not included in the received advertisement. Accordingly, the communication terminal 100 executes the connection action process with the environment information measuring device 200 (step S15). In step S15, the communication terminal 100 transmits a connection request signal to the environment information measuring device 200.

Next, upon receiving the connection request signal from the communication terminal 100, the environment information measuring device 200 accomplishes sending and receiving of data with the communication terminal 100 (step S16). In step S16, the environment information measuring device 200 transmits data such as the temperature, relative humidity and WBGT value and/or the like to the communication terminal 100.

When data sending and receiving between the environment information measuring device 200 and the communication terminal 100 ends, the communication terminal 100 executes a disconnection action process with the environment information measuring device 200 (step S17). In step S17, the communication terminal 100 transmits a disconnection request signal to the environment information measuring device 200. Upon receiving the disconnection request signal from the communication terminal 100, the environment information measuring device 200 transmits a response signal to the communication terminal 100 (step S18). Through this, the connection between the environment information measuring device 200 and the communication terminal 100 ends.

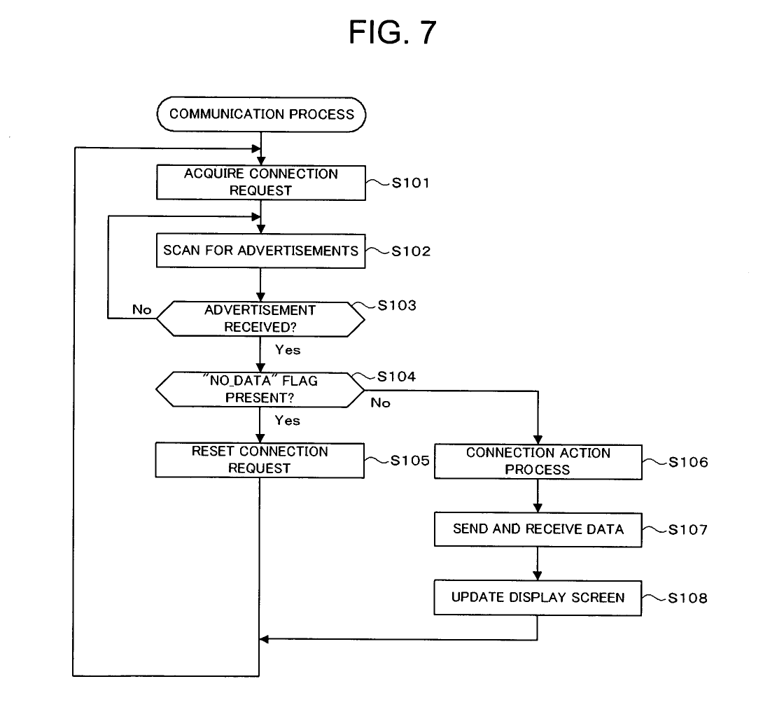

Next, the action of the communication terminal 100 according to this preferred embodiment is described with reference to FIG. 7. FIG. 7 is a flowchart showing one example of a communication process executed by the controller 102 of the communication terminal 100 according to this preferred embodiment. This communication process is accomplished by the controller 102, which reads out and executes a program stored in advance in the ROM 104.

The controller 102 of the communication terminal 100 starts the communication process shown in FIG. 7 after an application for environment information measuring is launched.

First, the connection request acquirer 151 acquires an operation to the touch panel 130 accomplished by a user for measuring the environment information, for example, as a request to connect to the environment information measuring device 200 (step S101).

The receiver 152 executes the receiving action process for receiving the advertisement. In the receiving action process, the receiver 152 scans for an advertisement (step S102) and determines whether or not an advertisement transmitted from the environment information measuring device 200 was received (step S103). When it is determined in step S103 that an advertisement was not received (step S103: no), the receiver 152 returns to step S102 and again scans for an advertisement.

When it is determined in step S103 that an advertisement was received (step S103: Yes), the determiner 153 determines whether or not the “no_data” flag indicating that there is no data that should be transmitted is included in the received advertisement (step S104). When it is determined in step S104 that the “no_data” flag is included (step S104: Yes), the connection controller 154 resets the connection request and does not execute the connection action process with the environment information measuring device 200 (step S105).

In addition, when it is determined in step S104 that the “no_data” flag is not included (step S104: No), the connection controller 154 executes the connection action process with the environment information measuring device 200 (step S106). In step S106, the connection controller 154 transmits the connection request signal to the environment information measuring device 200 as described above.

After the process of step S106 has been executed, the controller 102 accomplishes sending and receiving of data with the environment information measuring device 200 (step S107) and updates the display screen on the display device 128 based on the data received (step S108).

After the process of step S105 is executed, or after the process of step S108 is executed, the controller 102 returns to step S101 and repeatedly executes the above-described processes. The communication process ends for example when the user operates the touch panel 130 in order to cause the application for environment information measurement to end, and/or the like.

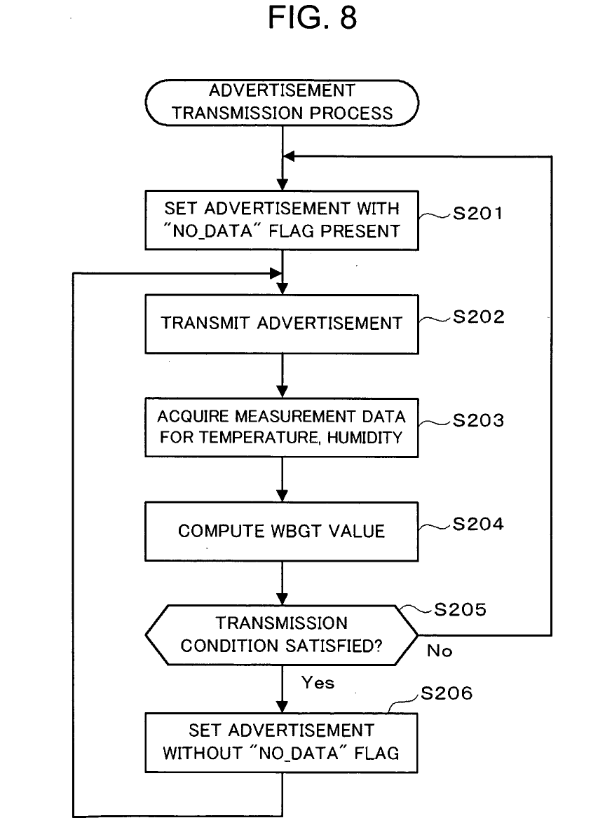

Next, the action of the environment information measuring device 200 according to this preferred embodiment is described with reference to FIG. 8. FIG. 8 is a flowchart showing one example of the advertisement transmission process executed by the controller 202 of the environment information measuring device 200 according to this preferred embodiment. This advertisement transmission process is accomplished by the controller 202, which reads and executes a program stored in advance in the ROM 204.

The controller 202 of the environment information measuring device 200 starts the advertisement transmission process shown in FIG. 8 after the power source is turned ON for example by operation of the operator 220 by a user.

First, the controller 202 accomplishes an advertisement setting including the “no_data” flag in the advertisement as an initial setting (step S201).

Next, the advertisement transmitter 253 transmits the advertisement to the communication terminal 100 (step S202). After the process of step S201 is executed, when the process of step S202 is executed the advertisement transmitter 253 transmits to the communication terminal 100 the advertisement including the “no_data” flag.

Next, the data acquirer 251 acquires data about the current temperature from the temperature sensor 230 and acquires data about the current relative humidity from the humidity sensor 240 (step S203).

The determiner 252 computes the WBGT value from the data about the temperature and relative humidity acquired by the data acquirer 251 (step S204), and determines whether or not the computed WBGT value is at least 25 degrees, that is to say, whether or not the transmission condition is satisfied (step S205).

When it is determined in step S205 that the transmission condition is satisfied (step S205: Yes), the controller 202 accomplishes an advertisement setting not including the “no_data” flag in the advertisement (step S206).

After the process of step S206 is executed, the controller 202 returns to step S202. When the process of step S202 is executed after the process of step S206 is executed, the advertisement transmitter 253 transmits to the communication terminal an advertisement not including the “no_data” flag.

In addition, when it is determined in step S205 that the transmission condition is not satisfied (step S205: No), the controller 202 returns to step S201 and repeatedly executes the above-described processes. The advertisement transmission process is temporarily interrupted for example when data transmission and reception is accomplished with the communication terminal 100. In addition, the advertisement transmission process concludes when the power source is turned OFF for example by operation of the operator 220 by a user.

As described above, with the communication terminal 100 according to the above-described preferred embodiment as explained above, connection with the environment information measuring device 200 is controlled based on whether or not specific information relating to data that should be transmitted, such as the “no_data” flag indicating that there is no data that should be transmitted, is included in the advertisement received from the environment information measuring device 200. Accordingly, it is possible to curb wasted power consumption.

With the communication terminal 100 according to the above-described preferred embodiment, when the “no_data” flag indicating that there is no data that should be transmitted is included in the advertisement received from the environment information measuring device 200, for example, the connection action process with the environment information measuring device 200 is not executed. Accordingly, it is possible to curb wasted power consumption.

With the environment information measuring device 200 according to the above-described preferred embodiment, when the transmission condition indicating the necessity of data transmission is not satisfied, for example, an advertisement including specific information relating to data that should be transmitted, such as a “no_data” flag indicating that there is no data that should be transmitted, is transmitted to the communication terminal 100. Through this, it is possible for the communication terminal 100 to not execute the connection action process with the environment information measuring device 200 based on the advertisement received. If the environment information measuring device 200 does not receive the connection request signal from the communication terminal 100, data such as the temperature, relative humidity and WBGT value and/or the like is not transmitted to the communication terminal 100, so it is possible to curb wasted power consumption.

With the environment information measuring device 200 according to the above-described preferred embodiment, when the transmission condition indicating the necessity of data transmission is not met, for example, an advertisement including the “no_data” flag indicating that there is no data that should be transmitted is transmitted to the communication terminal 100. Through this, it is possible for the communication terminal 100 to not execute the connection action process with the environment information measuring device 200 when the “no_data” flag is included in the received advertisement. Because the environment information measuring device 200 does not transmit data about the temperature, relative humidity, WBGT value and/or the like to the communication terminal 100 if a connection request signal is not received from the communication terminal 100, it is possible to curb wasted power consumption.

With the environment information measuring device 200 according to the above-described preferred embodiment, advertisements like that shown in FIG. 6 are transmitted to the communication terminal 100 at fixed intervals, so it is possible to appropriately switch between an advertisement including the “no_data” flag and an advertisement not including the “no_data” flag.

With the wireless communication system 1 according to the above-described preferred embodiment, when the “no_data” flag is not included in the advertisement transmitted by the environment information measuring device 200 like that shown in FIG. 6 for example, the communication terminal 100 executes the connection action process with the environment information measuring device 200 and accomplishes sending data to and receiving data from the environment information measuring device 200. In contrast, when the “no_data” flag is included in the advertisement transmitted by the environment information measuring device 200, the communication terminal 100 does not execute the connection action process with the environment information measuring device 200. In this case, the communication terminal 100 does not send data to and receive data from the environment information measuring device. 200. In this manner, data sending and receiving is not accomplished when there is no data that should be transmitted in the environment information measuring device 200, so it is possible to curb wasted power consumption.

The present disclosure is not limited to the above-described preferred embodiment, for various variations and applications are possible.

(Variation 1)

With the above-described preferred embodiment, the determination of whether or not the transmission condition indicating the necessity of data transmission was satisfied was a determination of whether or not the computed WBGT value was at least a standard value (25 degrees). However, the determination of whether or not the transmission condition is satisfied is not limited to the above, for it would be fine for example for the determination of whether or not the transmission condition indicating the necessity of data transmission is satisfied to be a determination of whether or not the classification to which the WBGT value computed this time belongs is the same classification to which the WBGT value computed at the time of the previous data transmission belongs. In this case, the determiner 252 determines that data transmission to the communication terminal 100 is necessary when the classification to which the WBGT value computed this time belongs differs from the classification to which the WBGT value computed at the time of the previous data transmission belongs. In addition, the determiner 252 determines that data transmission to the communication terminal 100 is unnecessary when the classification to which the WBGT value computed this time belongs is the same as the classification to which the WBGT value computed at the time of the previous data transmission belongs.

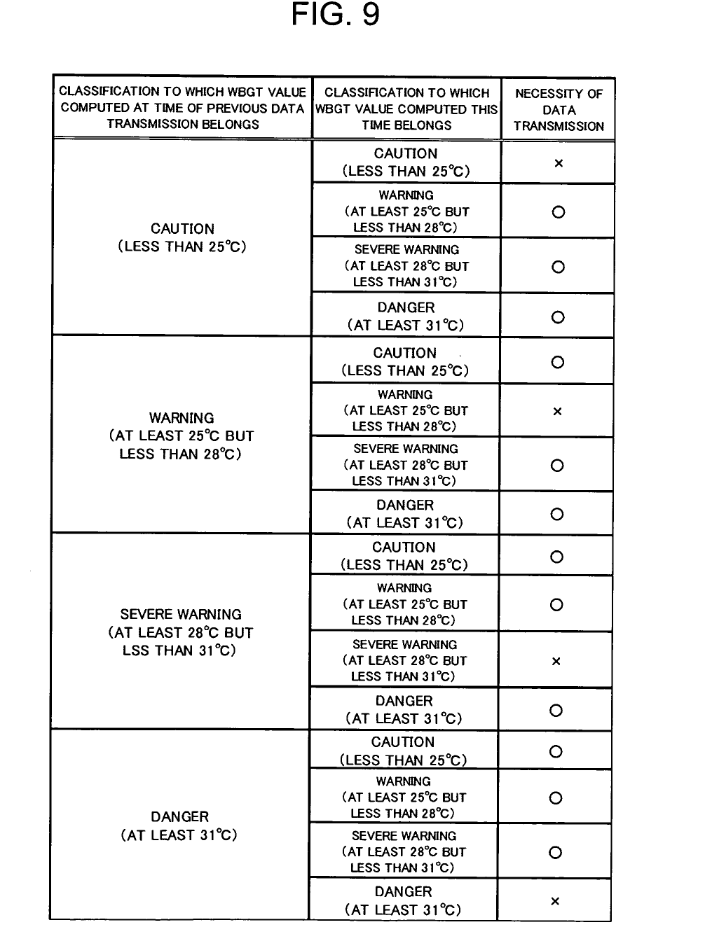

FIG. 9 is a drawing showing an example of the transmission condition indicating the necessity of data transmission.

As shown in FIG. 9, in a case where the classification to which the WBGT value computed at the time of the previous data transmission belongs is “caution” (the WBGT value is less than 25 degrees), for example, when the classification to which the WBGT value computed this time belongs is “caution” (WBGT values is less than 25 degrees), the determiner 252 determines that data transmission to the communication terminal 100 is unnecessary (indicated by “X” in FIG. 9). In addition, in a case where the classification to which the WBGT value computed at the time of the previous data transmission belongs is “caution” (the WBGT value is less than 25 degrees), for example, when the classification to which the WBGT value computed this time belongs is “warning” (the WBGT value is at least 25 degrees but less than 28 degrees), when the classification to which the WBGT value computed this time belongs is “severe warning” (the WBGT value is at least 28 degrees but less than 31 degrees), or when the classification to which the WBGT value computed this time belongs is “danger” (the WBGT value is at least 31 degrees), the determiner 252 determines that data transmission to the communication terminal 100 is necessary (indicated by “0” in FIG. 9).

In addition, the determiner 252 makes determinations similarly to the above when the classification to which the WBGT value computed at the time of the previous data transmission belongs is “warning” (the WBGT value is at least 25 degrees but less than 28 degrees), or when the classification is “severe warning” (the WBGT value is at least 28 degrees but less than 31 degrees), or when the classification is “danger” (the WBGT value is at least 31 degrees).

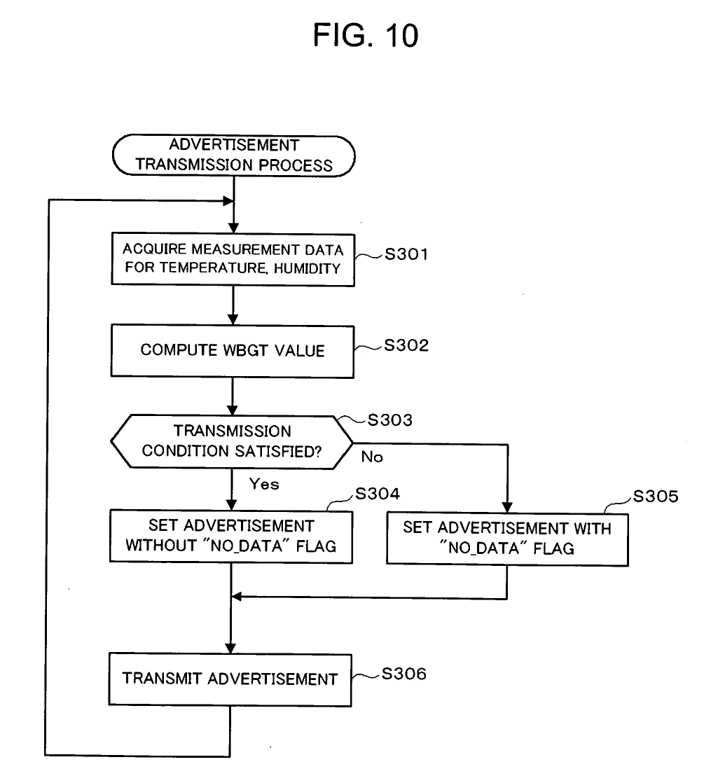

FIG. 10 is a flowchart showing another example of the advertisement transmission process executed by the environment information measuring device 200.

In the advertisement transmission process shown in FIG. 10, first the data acquirer 251 acquires data about the current temperature from the temperature sensor 230 and data about the current relative humidity from the humidity sensor 240 (step S301).

Next, the determiner 252 computes the WBGT value from the temperature and relative humidity data acquired by the data acquirer 251 (step S302), and determines whether or not the above-described transmission condition is satisfied, based on the computed WBGT value (step S303). Immediately after the power source of the environment information measuring device 200 is turned ON, data has not been transmitted even once to the communication terminal 100, so a WBGT value computed at the time of the previous data transmission does not exist. Accordingly, the classification to which the WBGT value computed this time belongs and classification to which the WBGT value computed at the time of the previous data transmission belongs differ, so it is determined that the transmission condition is satisfied.

When it is determined in step S303 that the transmission condition is satisfied (step S303: Yes), the controller 202 accomplishes an advertisement setting that does not include the “no_data” flag in the advertisement (step S304). In addition, when it is determined in step S303 that the transmission condition is not satisfied (step S303: No), the controller 202 accomplishes an advertisement setting that includes the “no_data” flag in the advertisement (step S305).

After the process of step S304 or the process of step S305 is executed, the advertisement transmitter 253 transmits the advertisement to the communication terminal 100 (step S306).

After the process of step S306 has been executed, the controller 202 returns to step S301 and repeatedly executes the above-described processes.

Even in this kind of composition, when the “no_data” flag is included in the advertisement received from the environment information measuring device 200, the connection action process with the environment information measuring device 200 is not executed in the communication terminal 100, and when the “no_data” flag is not included, the connection action process with the environment information measuring device 200 is executed, so it is possible to curb wasted power consumption.

(Variation 2)

With the communication terminal 100 according to the above-described preferred embodiment, when the “no_data” flag indicating there is no data that should be sent is included in the advertisement received from the environment information measuring device 200, the connection action process with the environment information measuring device 200 is not executed, but when the “no_data” flag is not included, the connection action process with the environment information measuring device 200 is executed. However, it would be fine for example to not execute the connection action process with the environment information measuring device 200 when a “data” flag indicating there is data that should be transmitted is not included in the advertisement received from the environment information measuring device 200 and to execute the connection action process with the environment information measuring device 200 when the “data” flag is included. In addition, it would be fine to not execute the connection action process with the environment information measuring device 200 when the “no_data” flag is included in the advertisement received from the environment information measuring device 200, and to execute the connection action process with the environment information measuring device 200 when the “data” flag is included. In this manner, it is possible to curb wasted power consumption.

(Variation 3)

With the environment information measuring device 200 according to the above-described preferred embodiment, an advertisement including the “no_data” flag indicating that there is no data that should be transmitted is transmitted to the communication terminal 100 when the transmission condition indicating the necessity of data transmission is not satisfied, and an advertisement not including the “no_data” flag is transmitted to the communication terminal 100 when the above-described transmission condition is satisfied. However, it would be fine, for example, to transmit to the communication terminal 100 an advertisement including a “data” flag indicating that there is data that should be transmitted, when the transmission condition indicating the necessity of data transmission is satisfied, and to transmit to the communication terminal 100 an advertisement not including the “data” flag when the above-described transmission condition is not satisfied. In addition, it would be fine to transmit to the communication terminal 100 an advertisement including the “data” flag indicating that there is data that should be transmitted, when the transmission condition indicating the necessity of data transmission is satisfied, and to transmit to the communication terminal 100 an advertisement including the “no_data” flag indicating there is no data that should be transmitted, when the above-described transmission condition is not satisfied. When the “data” flag is included in the advertisement, it would be fine to create an area in the advertisement packet where the “data” flag can be set, and in this area to set data such as “0x11” as data indicating the “data” flag. In doing this, it is possible to curb wasted power consumption.

Above, the preferred embodiment and variations thereof were described, but the present disclosure is not limited by the above-described preferred embodiment and variations thereof.

With the above-described preferred embodiment, the wireless communication system 1 comprises the communication terminal 100 as the central and the environment information measuring device 200 as the peripheral. However, the wireless communication system 1 is not limited to comprising the communication terminal 100 and the environment information measuring device 200. For example, it would be fine for the wireless communication system 1 to comprise the communication terminal 100 and an alarm device provided with sensors for detecting trespassing as the peripheral. In this case, for example when the alarm device detects trespassing, it would be fine to transmit to the communication terminal 100 an advertisement not including the “no_data” flag. In addition, it would be fine for example for the wireless communication system 1 to comprise the communication terminal 100 and a pollen measuring device as the peripheral, with the pollen measuring device provided with a sensor for measuring pollen quantities. In this case, it would be fine for example to transmit to the communication terminal 100 an advertisement not including the “no_data” flag when the pollen quantity measured by the pollen measuring device exceeds a standard value.

With the above-described preferred embodiment, a smartphone was taken as the central, but the wireless communication device comprising the central is not limited to a smartphone. For example, it would be fine to take a wristwatch and/or the like capable of wireless communication based on BLE as the central and a smartphone or mobile phone and/or the like having an email-receiving function as the peripheral. In this case, when the smartphone and/or the like receives email, it would be fine to transmit to the wristwatch and/or the like an advertisement not including the “no_data” flag. With this kind of composition, it is possible to cause the wristwatch and/or the like to display the fact that email was received.

With the above-described preferred embodiment, the wireless communication system 1 as shown in FIG. 1 comprises one central (the communication terminal 100) and one peripheral (the environment information measuring device 200). However, it would be fine for the wireless communication system 1 to comprise one or multiple centrals and one or multiple peripherals. When there are multiple peripherals, it would be fine for the central to receive advertisements successively from the peripherals. In addition, where there are multiple centrals, it would be fine for a peripheral to start sending and receiving data with the centrals in the order in which connection request signals were received.

In addition, the communication terminal 100 and the environment information measuring device 200 according to the present disclosure can be realized using a regular computer system and not specialized devices. For example, it would be fine to realize the functions of the connection terminal 100 and the environment information measuring device 200 by a computer executing a program. The program for realizing the functions of the connection terminal 100 and the functions of the environment information measuring device 200 may be stored on a computer-readable non-transitory recording medium such as USB (Universal Serial Bus) memory, an SD (Secure Digital) memory card, a CD-ROM (Compact Disc Read Only Memory), a DVD (Digital Versatile Disc), a BD (Blu-ray® Disc), an HDD (Hard Disk Drive) and/or the like, and it would also be fine for the program to be downloaded to a computer via a network.

Having described and illustrated the principles of this application by reference to one or more preferred embodiments, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

This application claims the benefit of Japanese Patent Application No. 2013-132120, filed on Jun. 24, 2013, the entire disclosure of which is incorporated by reference herein.

### REFERENCE SIGNS LIST

1 Wireless communication system
100 Communication terminal
102 Controller
104 ROM
106 RAM
110 Wireless communication processor
112 Antenna
124 Speaker
126 Driver
128 Display device
130 Touch panel
151 Connection request acquirer
152 Receiver
153 Determiner
154 Connection controller
200 Environment information measuring device
202 Controller
204 ROM
206 RAM
210 Wireless communication processor
212 Antenna
220 Operator
226 Driver
228 Display device
230 Temperature sensor
240 Humidity sensor
251 Data acquirer
252 Determiner
253 Advertisement transmitter
254 Connection request receiver
255 Data transmitter

1. A wireless communication device, comprising:
a connection request acquirer which acquires a connection request to connect to an other wireless communication device;
a receiver which receives identifying information from the other wireless communication device in response to the connection request being acquired by the connection request acquirer;
a determiner which determines whether or not specific information relating to data that the other wireless communication device should transmit is included in the identifying information received by the receiver; and
a connection controller which controls connections with the other wireless communication device, based on the determination result from the determiner.

2. The wireless communication device according to claim 1, wherein:
the determiner determines whether or not specific information indicating that there is no data that should be transmitted by the other wireless communication device is included; and
the connection controller does not connect to the other wireless communication device when it is determined by the determiner that specific information indicating that there is no data that should be transmitted by the other wireless communication device is included.

3. The wireless connection device according to claim 1, wherein:
the determiner determines whether or not specific information indicating that there is data that should be transmitted by the other wireless communication device is included; and
the connection controller connects to the other wireless communication device when it is determined by the determiner that specific information indicating that there is data that should be transmitted by the other wireless communication device is included.

4. A wireless communication device for accomplishing wireless communication with an other wireless communication device, the wireless communication device comprising:
a data acquirer which acquires data;
a determiner which determines whether or not data acquired by the data acquirer satisfies a transmission condition indicating the necessity of data transmission to the other wireless communication device;
an identifying information transmitter which transmits identifying information to the other wireless communication device based on the determination result of the determiner, the identifying information including specific information related to data that should be transmitted;
a connection request receiver which receives a connection request signal transmitted based on the identifying information by the other wireless communication device that received the identifying information transmitted by the identifying information transmitter; and
a data transmitter which transmits data acquired by the data acquirer to the other wireless communication device, in accordance with the connection request signal received by the connection request receiver.

5. The wireless communication device according to claim 4, wherein the identifying information transmitter transmits to the other wireless communication device identifying information including specific information indicating that there is no data that should be transmitted, when it is determined by the determiner that the transmission condition is not satisfied.

6. The wireless communication device according to claim 4, wherein the identifying information transmitter transmits to the other wireless communication device identifying information including specific information indicating that there is data that should be transmitted, when it is determined by the determiner that the transmission condition is satisfied.

7. The wireless communication device according to claim 4, wherein the identifying information transmitter transmits the identifying information at fixed intervals to the other wireless communication device.

8. A wireless communication system comprising:
a wireless communication device comprising:
a connection request acquirer which acquires a connection request to connect to an other wireless communication device,
a receiver which receives identifying information from the other wireless communication device in response to the connection request being acquired by the connection request acquirer,
a determiner which determines whether or not specific information relating to data that the other wireless communication device should transmit is included in the identifying information received by the receiver, and
a connection controller which controls connections with the other wireless communication device, based on the determination result from the determiner; and
an other wireless communication device for accomplishing wireless communication with the wireless communication device, the other wireless communication device comprising:
a data acquirer which acquires data, a determiner for determining whether or not data acquired by the data acquirer satisfies a transmission condition indicating the necessity of data transmission to the wireless communication device,
an identifying information transmitter which transmits identifying information to the wireless communication device based on the determination result of the determiner,
the identifying information including specific information related to data that should be transmitted,
a connection request receiver which receives a connection request signal transmitted based on the identifying information by the wireless communication device that received the identifying information transmitted by the identifying information transmitter, and
a data transmitter which transmits data acquired by the data acquirer to the wireless communication device, in accordance with the connection request signal received by the connection request receiver.

9. A wireless communication method, including:
a connection request acquisition step for acquiring a connection request to connect to an other wireless communication device;
a reception step for receiving identifying information from the other wireless communication device in response to the connection request being acquired in the connection request acquisition step;
a determination step for determining whether or not specific information relating to data that the other wireless communication device should transmit is included in the identifying information received in the reception step; and
a connection control step for controlling connections with the other wireless communication device, based on the determination result from the determination step.

10. A wireless communication method for accomplishing wireless communication with an other wireless communication device, the wireless communication method including:
a data acquisition step for acquiring data;
a determination step for determining whether or not data acquired in the data acquisition step satisfies a transmission condition indicating the necessity of data transmission to the other wireless communication device;
an identifying information transmission step for transmitting identifying information to the other wireless communication device based on the determination result of the determination step, the identifying information including specific information related to data that should be transmitted;
a connection request reception step for receiving a connection request signal transmitted based on the identifying information by the other wireless communication device that received the identifying information transmitted in the identifying information transmission step; and
a data transmission step for transmitting data acquired in the data acquisition step to the other wireless communication device, in accordance with the connection request signal received in the connection request reception step.

11. A computer-readable non-transitory recording medium on which is stored a program for causing a computer to function as:
connection request acquisition means for acquiring a connection request to connect to an other wireless communication device;
receiving means for receiving identifying information from the other wireless communication device in response to the connection request being acquired by the connection request acquisition means;
determination means for determining whether or not specific information relating to data that the other wireless communication device should transmit is included in the identifying information received by the receiving means; and
connection control means for controlling connections with the other wireless communication device, based on the determination result from the determination means.

12. A computer-readable non-transitory recording medium on which is stored a program for causing a computer that accomplishes wireless communication with an other wireless communication device to function as:
data acquisition means for acquiring data;
determination means for determining whether or not data acquired by the data acquisition means satisfies a transmission condition indicating the necessity of data transmission to the other wireless communication device;
identifying information transmission means for transmitting identifying information to the other wireless communication device based on the determination result of the determination means, the identifying information including specific information related to data that should be transmitted;
connection request receiving means for receiving a connection request signal transmitted based on the identifying information by the other wireless communication device that received the identifying information transmitted by the identifying information transmission means; and
data transmission means for transmitting data acquired by the data acquisition means to the other wireless communication device, in accordance with the connection request signal received by the connection request receiving means.

13. A central that accomplishes wireless communication with a peripheral, the central comprising:
a connection request acquirer which acquires a connection request to connect to the peripheral;
a receiver which receives an advertisement from the peripheral in response to the connection request being acquired by the connection request acquirer;
a determiner which determines whether or not specific information relating to data that the peripheral should transmit is included in the advertisement received by the receiver; and
a connection controller which controls connections with the peripheral, based on the determination result from the determiner.

14. A peripheral that accomplishes wireless communication with a central, the peripheral comprising:
a data acquirer which acquires data;
a determiner which determines whether or not data acquired by the data acquirer satisfies a transmission condition indicating the necessity of data transmission to the central;
an advertisement transmitter which transmits an advertisement to the central based on the determination result of the determiner, the advertisement including specific information related to data that should be transmitted;
a connection request receiver which receives a connection request signal transmitted based on the advertisement by the central that received the advertisement transmitted by the advertisement transmitter; and
a data transmitter which transmits data acquired by the data acquirer to the central, in accordance with the connection request signal received by the connection request receiver.
